(19) United States
(12) Patent Application Publication
(10) Pub. No.: US 2021/0141946 A1
(43) Pub. Date: May 13, 2021

(54) SYSTEM, DEVICE AND METHOD FOR PROTECTING INFORMATION OF A PAYMENT TRANSACTION USING TAMPER-RESISTANT PORTABLE STICK COMPUTER DEVICE

(71) Applicant: Cheol Jae Lee, Porter Ranch, CA (US)

(72) Inventor: Cheol Jae Lee, Porter Ranch, CA (US)

(21) Appl. No.: 16/844,971

(22) Filed: Apr. 9, 2020

Related U.S. Application Data
(60) Provisional application No. 62/934,384, filed on Nov. 12, 2019.

(51) Int. Cl. G06F 21/87; H04L 9/08; G06F 1/26; G06Q 20/38

(52) U.S. Cl. CPC G06F 21/87; H04L 9/0894; G06Q 2220/00; G06Q 20/382; G06F 1/26

(57) ABSTRACT

The present invention relates to a system, device and method for protecting payment transactions using a tamper-resistant portable stick computer device. The system includes a tamper-resistant portable computing device; a display connected with the tamper-resistant portable computing device; and an external device for processing the payment transactions. The tamper-resistant portable computing device includes a case; a processor and a tamper-resistant circuit; a substrate constructed to mount at least one of electric components on a side of the substrate; a first cover to cover the electric components mounted on the side of the substrate; and conductive metal springs disposed on the substrate in contact with the electric contacts of the conductive pattern to establish an electrical connection between the tamper-resistant circuit and the first cover.

### CROSS-REFERENCE TO RELATED APPLICATIONS

This application claims priority to U.S. provisional patent application No. 62/934,384, filed Nov. 12, 2019, the disclosures of which are incorporated herein by reference in their entirety.

### FIELD OF THE INVENTION

The present invention relates to a system, device, and method for protecting payment transactions using a tamper-resistant portable stick computer device, more particularly, to a system and method for protecting payment transactions through a secured portable stick computer device having a physical tamper-resistant cover structure and tamper-resistant circuits to prevent physical hacking when it is in operation or lost.

### BACKGROUND OF THE INVENTION

The present invention relates to a system, device, and method for protecting payment transactions using tamper-resistant portable stick computer device to provide a more secure payment transaction in a compact form factor. As shown in FIG. 10, existing payment transaction devices consist of many different components such as CPU(s) 706, memory module(s) 705, wireless network modules 704, a contact or contactless card reader 707, a PIN entry keypad 701, a printer 703, a display 702, and a magnetic stripe card reader 708 for executing payment transactions using applications and programs loaded, side-loaded, or stored on the device. Together, these hardware and software functions are integrated in a single device used for payment transactions.

In addition, existing portable computer devices need to be secured against potential hacking. For example, portable stick-type computer devices are defenseless against hacking when such devices are lost or stolen. Thus, there exists a need for such portable computer devices to be constructed and/or configured with security improvements in mind (e.g. hacking defense technology) in response to the continued advancement of hacking technology.

In order to solve this problem and meet a long-felt need, the present invention includes main hardware and software, the latter of which is configured to control system execution among functions that are embedded in a tamper-resistant portable stick computer device. The tamper-resistant portable stick computer device provides connection ports and a wireless communication network for connecting to, or interfacing with, external devices including (but not limited to) POS terminal, card reader, cash register, PIN pad & NFC reader, printer, check reader and barcode scanner, and the like, wherein any of the aforementioned are not limited to the type or number of payment transaction apparatus. By selectively connecting to the necessary external device(s), it is possible to configure a variety of functions that are tied to the tamper-resistant portable stick computer device, which altogether creates a unique product group having distinct advantages when compared to its competitors.

Further, the present invention includes a physical tamper-resistant cover covering a main CPU and memories (volatile and non-volatile), the storage component of latter non-volatile memory (e.g. flash memory, ROM, PROM, EPROM and EEPROM memories, etc.) may be constructed and configured to store important contents, including (but not limited to) application programs, user data, and card information. Further included in the present invention is a tamper-resistant circuit (can be one or more circuits) added to the computer circuit board, the tamper-resistant circuit being constructed and configured to detect hacking such that the security of the present invention is hardened. The present invention including the physical tamper-resistant cover and the tamper-resistant circuits provide security not only by encrypting the contents in memory akin to existing portable computer devices but also by rendering the portable computer devices completely and permanently inoperable when hacked, thus preventing reuse of all or some of the parts (hardware and software) of the portable computer devices when attempting to breach its security. The present invention can be used in areas like the military, Internet of Things, etc., that require the highest degree of security.

### SUMMARY OF THE INVENTION

The present invention contrives to solve the disadvantages and shortcomings of the prior art by providing a system, device, and method for protecting payment transactions using a tamper-resistant portable stick computer device through a secured portable stick computer device having a physical tamper-resistant cover structure and tamper-resistant circuits to prevent physical hacking when it is in operation or lost.

The object of the invention is to provide a system for protecting information of payment transactions, which includes a tamper-resistant portable computing device, a display connected with the tamper-resistant portable computing device; and an external device for processing the payment transactions. The tamper-resistant portable computing device includes a case, a processor and a tamper-resistant circuit, a substrate constructed to mount at least one of electric components on a side of the substrate, and wherein the electric components include the processor, a first cover to cover the electric components mounted on the side of the substrate wherein the first cover includes a conductive pattern inside of the first cover, and wherein the conductive pattern includes electric contacts on each end of the conductive pattern; and conductive metal springs disposed on the substrate in contact with the electric contacts of the conductive pattern to establish an electrical connection between the tamper-resistant circuit and the first cover.

The tamper-resistant portable computing device is operative to protect the information of the payment transactions by the steps of, the tamper-resistant portable computing device: encrypting, via an encryption key in a volatile memory, a bootloader, a kernel, and an application and storing an encrypted bootloader in the volatile memory; decrypting, by the encrypted bootloader, the kernel and the application encrypted by the encryption key in the volatile memory, and executing the application; detecting, by the processor and the tamper-resistant circuit, a hacking detection signal when physical tampering of the tamper-resistant portable computing device disconnects the electrical connection between the first cover and the tamper-resistant circuit; displaying the disconnection status of the electrical connection of the tamper-resistant circuit on the display when the hacking detection signal is detected by the processor and the tamper-resistant circuit; and erasing the encryption key stored in the volatile memory such that an operation of the tamper-resistant portable computing device is disabled permanently.

Preferably, the steps further include: generating a hacking detection electrical output signal, by the tamper-resistant circuit and the processor, wherein the hacking detection electrical output signal is passed through to one of the conductive metal springs and to the conductive pattern; and inputting a hacking detection electrical input signal which is passed through from the conductive pattern to the other conductive metal spring into the tamper-resistant circuit and the processor. The first cover further includes both a top surface and side walls defining a cavity enclosing the electronic components. The first cover further includes a insulating coating layer of an inner surface of the first cover and a rigid portion of a outer surface of the first cover, and wherein the conductive pattern is disposed between the insulating coating layer and the rigid portion. The substrate includes a conductive border on the substrate wherein the conductive border surrounds about the electric components, and wherein a bottom of the first cover is disposed on the conductive border.

Additionally, the system includes a second cover to cover at least one additional electronic components mounted on an opposite side of the substrate wherein the first cover and the second cover are the same shape and size, and wherein the second cover is disposed to be substantially aligned with respect to the first cover. The external device is connected with the tamper-resistant portable computing device through a universal serial bus (USB) port and wireless Bluetooth.

The steps may further include: receiving the information of the payment transactions through the external device for processing the payment transactions and the payment. The external device is a contact/contactless card and PIN entry device, a cash register, a barcode scanner, or a magnet card reader.

The application is a Point of Sale (POS) program stored in a non-volatile memory of the tamper-resistant portable computing device, and wherein the information of payment transactions is a payment card number, user information, a card transaction status, or an order status stored in a non-volatile memory of the tamper-resistant portable computing device.

Another object of the invention is to provide a tamper-resistant portable computing device for protecting information of payment transactions and the tamper-resistant portable computing device is connected with a display, the tamper-resistant portable computing device comprising: a case; a processor and a tamper-resistant circuit; a substrate constructed to mount at least one of electric components on a side of the substrate, and wherein the electric components include the processor and the tamper-resistant circuit; a first cover to cover the electric components mounted on the side of the substrate wherein the first cover includes a conductive pattern inside of the first cover, and wherein the conductive pattern includes electric contacts on each end of the conductive pattern; and conductive metal springs disposed on the substrate in contact with the electric contacts of the conductive pattern to establish an electrical connection between the tamper-resistant circuit and the first cover. The tamper-resistant portable computing device is operative to protect the information of the payment transactions by the steps of, the tamper-resistant portable computing device: encrypting, via an encryption key in a volatile memory, a bootloader, a kernel, and an application and storing an encrypted bootloader in the volatile memory; decrypting, by the encrypted bootloader, the kernel and the application encrypted by the encryption key in the volatile memory, and executing the application; detecting, by the processor and the tamper-resistant circuit, a hacking detection signal when physical tampering of the tamper-resistant portable computing device disconnects the electrical connection between the first cover and the tamper-resistant circuit; displaying the disconnection status of the electrical connection of the tamper-resistant circuit on the display when the hacking detection signal is detected by the processor and the tamper-resistant circuit; and erasing the encryption key stored in the volatile memory such that an operation of the tamper-resistant portable computing device is disabled permanently.

Still another object of the invention is to provide a method for protecting information of payment transactions by a tamper-resistant portable computing device comprising the steps of: encrypting, via an encryption key in a volatile memory, a bootloader, a kernel, and an application and storing an encrypted bootloader in the volatile memory; decrypting, by the encrypted bootloader, the kernel and the application encrypted by the encryption key in the volatile memory, and executing the application; detecting, by the processor and the tamper-resistant circuit, a hacking detection signal when physical tampering of the tamper-resistant portable computing device disconnects the electrical connection between the first cover and the tamper-resistant circuit; displaying the disconnection status of the electrical connection of the tamper-resistant circuit on the display when the hacking detection signal is detected by the processor and the tamper-resistant circuit; and erasing the encryption key stored in the volatile memory such that an operation of the tamper-resistant portable computing device is disabled permanently. The method further includes the steps of: generating a hacking detection electrical output signal, by the tamper-resistant circuit and processor, the hacking detection electrical output signal which is passed through to one of the conductive metal springs and to the conductive pattern; inputting a hacking detection electrical input signal which is passed through from the conductive pattern to the other conductive metal spring into the tamper-resistant circuit and the processor; and receiving the information of the payment transactions through an external device for processing the payment transactions and the payment.

The advantages of the present invention are: (1) selective connectivity with necessary external payment transaction devices to allow configuration of a variety of functions, and create a unique product group apart from its competitors; (2) merchants may replace a workstation operating their payment transaction system with the payment transaction system using a tamper-resistant portable stick computer device; (3) a physical tamper-resistant cover constructed to cover a main CPU and memory (volatile and non-volatile) to store important contents, and a hacking detection circuit added to the computer circuit board to prevent hacking (physical and non-physical); and (4) optimization of the present invention for portable stick computer devices that, in a small form factor, can securely protect all programs and important data in the memory from hacking when the portable computer device is lost.

Although the present invention is briefly summarized, the fuller understanding of the invention can be obtained by the following drawings, detailed description, and appended claims.

### BRIEF DESCRIPTION OF THE DRAWINGS

These and other features, aspects, and advantages of the present invention will become better understood with reference to the accompanying drawings, wherein:

FIG. 1 is a front exploded view of the tamper-resistant portable stick computer device according to the present invention;

FIG. 2 is a perspective exploded view of the tamper-resistant portable stick computer device according to the present invention;

FIG. 3 is a perspective view of a cover and a substrate of the tamper-resistant portable stick computer device according to the present invention;

FIG. 4A is a cross-sectional view of the tamper-resistant portable stick computer device according to the present invention, FIGS. 4B and 4C are partial cross-sectional views of the tamper-resistant portable stick as represented by the dotted rectangular area of X;

FIG. 5 is a schematic illustration of components of the tamper-resistant portable stick computer device according to the present invention;

FIG. 6 is a diagram showing a hardware and software structure of the tamper-resistant portable stick computer device according to the present invention;

FIG. 7 is a diagram showing running application of the tamper-resistant portable stick computer device according to the present invention; and

FIG. 8 is a schematic illustration of a system for a payment transaction using tamper-resistant portable stick computer device according to the present invention;

FIG. 9 is another schematic illustration of a display of application for a payment transaction and the tamper-resistant portable stick computer device according to the present invention;

FIG. 10 is a conventional payment transaction apparatus;

FIG. 11 is a side view of an interior of tamper-resistant portable stick computer device according to the present invention that is partially dissembled;

FIG. 12 is another side view of an interior of tamper-resistant portable stick computer device according to the present invention that is partially dissembled;

### DETAILED DESCRIPTION OF THE EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations by use of the word “about”, it will be understood that the particular value forms another embodiment.

FIG. 1 is a front exploded view of the tamper-resistant portable stick computer device according to the present invention, FIG. 2 is a perspective exploded view of the tamper-resistant portable stick computer device according to the present invention, and FIG. 3 is a perspective view of a cover and a substrate of the tamper-resistant portable stick computer device according to the present invention.

As shown FIGS. 1-3, the present invention includes a portable stick type computer device 10 whose main components are cases 100, 113, a substrate 120, a power source 111, a wireless communication module 101, a central processing unit (CPU) 102, memory 103, a USB communication port 104, a video output port 105, coin battery 110, tamper resistant cover 107 and taper resistant circuit 106. As shown in FIG. 1, the cases 100, 113 include an upper case 100 to cover a first side 122 of the substrate 120 and a lower case 113 to cover a second side 124 of the substrate 120. The substrate 120 may be a printed circuit board (PCB). Electric components 20 may include a CPU (a processor) 102, memory 103, a USB communication port 104, and a video output port 105. The substrate 120 is constructed to mount at least one of electric components 20 on a side of the substrate 120. The electric components 20 may be inserted or mounted on both sides of the substrate 120. The power source 111 receives input from an external DC power or AC power adapter. The wireless communication module 101 enables wireless communication that complies with the IEEE 802.11(g/b/n) Wi-Fi standard and enables wireless communication that conforms to the Bluetooth (IEEE 802.15.1) standard. The operating system (OS) manages the CPU 102, the latter of which is a processor that may execute an OS program or applications, communicate with and between hardware and software elements, and control the same. Memory 103 is non-volatile memory which may be a ROM (Read Only Memory), an EEPROM (Electrically Erasable and Programmable ROM), a flash memory, hard disk drive, SD card (standard/micro) storage or any similar storage element, wherein the memory 103 may include one or more modules listed above. The USB communication port 104 provides the ability to attach numerous USB devices (via a USB hub 502) to a single USB port of other devices, preferably devices that includes payment transaction devices (e.g. POS terminal, card reader, cash register, PIN pad & NFC, printer, check reader, barcode scanner, etc.). There is no limit to the type or number of payment transaction apparatus that may be connected directly or indirectly with any of the embodiments of the present invention.

The video output port 105 may connect with a display device such as a monitor, a tablet, or any other electronic device with a display, through an HDMI or USB cable. Additional elements of the portable computer device 10 that prevent hacking includes tamper-resistant circuits 106, a physical tamper-resistant cover 107, conductive metal springs 108 and 109, and a coin battery 110. Alternatively, the conductive metal springs 108, 109 may be use conductive elastomers. The tamper-resistant cover 107 is configured to be closed on both the top surface and side walls. The tamper-resistant cover may include both a top surface and side walls defining a cavity enclosing the electronic components 20. Alternatively, the tamper-resistant cover 107 may include a first cover 107, and a second cover 107′. The first cover 107 may be installed inside the upper case 100 on the first side 122 of the substrate 120 of the portable computer device 10. The second cover 107′ may be installed inside the lower case 113 on the second side 124 of the substrate 120 of the portable computer device 10 to cover objects to be protected, namely the CPU 102, the wireless communication module 101, and memory 103.

As shown FIGS. 3 and 4, the conductive metal springs 108, 109 establish an electrical connection with the tamper-resistant covers 107, 107′, the tamper-resistant circuits 106, and the CPU 102 such that the conductive metal springs 108, 109 function similarly to a mechanical switch as part of protecting embodiments of the present invention against physical hacking. The tamper-resistant covers 107, 107′ may include conductive patterns 200 inside thereof. The conductive pattern may include electric contacts 201, 202 on each end of the conductive pattern 200. Specifically, when removing the tamper-resistant covers 107, 107′ from the substrate 120 or drilling a hole through the tamper-resistant covers 107, 107′ to manipulate or remove the object to be protected, conductive patterns 200 installed inside the tamper-resistant covers 107, 107′ are disconnected from the electrical connection established by contacts 201, 202. The conductive metal springs 108, 109 disposed on the substrate 120 in contact with the electric contacts 201, 202 of the conductive patterns 200 establish an electrical connection between the tamper-resistant circuit 106 and the first cover 107. More specifically, when the contacts 201 and 202 are electrically disconnected from the conductive metal springs 108 and 109, the tamper-resistant circuits 106 and the CPU 102 detect the electrical disconnection. For example, when drilling a hole through the upper case 107 or the second cover 107′, the conductive patterns 200 are physically damaged or disconnected, which leads to an electrical disconnection that would be detected by the tamper-resistant circuits 106 and the CPU 102. The first cover 107 may cover the electric components 20 mounted on the first side 122 of the substrate 120 wherein the first cover 107 includes a conductive pattern 200 inside thereof. The second cover 107′ is configured to cover at least one additional electronic components 20 mounted on the second side 124 of the substrate 120 wherein the first cover 107 and the second cover 107′ are substantially the same shape and size, and wherein the second cover 107′ is disposed to be substantially aligned with respect to the first cover 107. During normal operation, a hacking detection electrical output signal 203 (generated by the tamper-resistant circuits 106 and the CPU 102) is passed through to the conductive metal spring 108 and to the conductive pattern 200. At this location, the hacking detection electrical output signal 203 can now be referred to as a hacking detection electrical input signal 204 from the inner conductive pattern 200 which is then passed through to the conductive metal spring 109 and then inputs into the tamper-resistant circuits 106 and the CPU 102. The tamper-resistant circuits 106 and the CPU 102 detect electrical signals 203 and 204 to determine whether they are disconnected from each other. If the electrical signals 203 and 204 are disconnected, then the tamper-resistant circuits 106 and the CPU 102 forcibly erase keys and the CPU 102 becomes inoperable permanently.

Further, as shown in FIGS. 3 and 4A-4C the cover 107 includes a rigid portion 140 made of rigid material, one or more conductive patterns layer 200 made of conductive material, and at least one insulating coating 130 that is interposed between the rigid portion 140 and the conductive patterns layer 200, where the aim of the at least one insulating coating 130 is to electrically isolate the conductive patterns 200 and the rigid portion 140 from each other. Preferably, the tamper-resistant covers 107, 107′ may include respectively a insulating coating layer 130 of an inner surface of the tamper-resistant covers 107, 107′ and a rigid portion 140 of a outer surface of tamper-resistant covers 107, 107′, and wherein the conductive pattern 200 is disposed between the insulating coating layer 130 and the rigid portion 140.

As shown in FIG. 4B, when the conductive patterns layer 200 is a plurality of layers, there is a plurality of insulating coatings 130 where each of the insulating coatings 130 are interposed between the conductive patterns layers 200. Preferably, the rigid portion 140 is made of the following (individually or in any combination thereof): aluminum, silicon, hard material, plastic material, metallic material, or the like. The conductive patterns 200 installed inside the cover are not exposed to the outside, and thus, the conductive patterns 200 cannot be seen outside the cover. As shown, the conductive patterns 200 may adopt a partial stripe shape that includes a pattern of rectangular waves, but such shapes and patterns may not be limited thereto as the conductive patterns 200 can adopt alternative configurations. The tamper-resistant circuits 106 and the CPU 102 use the coin battery 110 as a power source while the device 10 is not connected to an external power source. When replacing the coin battery 110, the user will open the battery cover 112 to replace it. The battery may be, but is not limited to, a lithium battery or a lithium-ion battery. Any type of battery can be used. as long as these batteries have the same or equivalent function as the exemplary batteries.

As shown FIGS. 5 and 6, after programs and data 301 are encrypted and saved in the memory 103, the former function using an encryption key 300 stored in a volatile memory 302 in the tamper-resistant circuits 106 and the CPU 102, and the encrypted programs and data are stored in the non-volatile memory 103. The tamper-resistant circuits 106 and the CPU 102 detect electrical signals 203 and 204 to determine whether they are hacked or not. If a hacking is detected, the encryption key 300 stored in the volatile memory in the tamper-resistant circuits 106 and the CPU 102 is forcibly erased and the CPU 102 becomes inoperable. All programs and data 301 operating in the present invention 10 are encrypted with the encryption key 300 and, after hacking, all programs are permanently disabled (e.g. non-executable) due to the erasure of the encryption key 300 and the now permanently disabled CPU 102.

As shown FIG. 6-7, the portable computer device software includes a bootloader 303, a kernel 320, and at least one application 330. The bootloader 310 is encrypted by the encryption key 300 in volatile memory in the CPU 102 and stored in CPU 102 in step 400. Alternatively, the volatile memory may be configured to be separate from the CPU 102. The bootloader 310 runs only the kernel 320 and the application 330, the application 330 encrypted with the encryption key 300 and authenticated in step 401. Bootloader 310 and the kernel 320 may monitor hacking status by the tamper-resistant circuits 106 and the CPU 102 in real time in step 402. If the portable computer device 10 is hacked during operation, the bootloader 310 and the kernel 320 report the hacking status to the monitor screen connected to video output port 105 and immediately the tamper-resistant circuits 106 and CPU 102 forcibly erase the encryption key 300. If the portable computer device 10 is hacked when an external power source is not provided, the volatile memory which is stored the encryption key 300, the tamper-resistant circuits 106, the tamper-resistant covers and the CPU 102 still receive power by the coin battery 110, which allows the tamper-resistant circuits 106 and the CPU 102 to forcibly erase the encryption key 300 in step 403.

Preferably, a tamper-resistant portable computer device 10 for protecting information of payment transactions and the tamper-resistant portable computer device may be connected with a display. The tamper-resistant portable computer device 10: encrypting, via an encryption key 300 in a volatile memory 302, a bootloader 310, a kernel 320, and an application 330 and storing an encrypted bootloader 310 in the volatile memory 302; decrypting, by the encrypted bootloader 310, the kernel 320 and the application 330 encrypted by the encryption key 300 in the volatile memory 302, and executing the application 330; detecting, by the processor 102 and the tamper-resistant circuit 106, a hacking detection signal 203 or 204 when physical tampering of the tamper-resistant portable computer device 10 disconnects the electrical connection between the first cover and the tamper-resistant circuit 106; displaying the disconnection status of the electrical connection of the tamper-resistant circuit 106 on the display when the hacking detection signal 203 or 204 is detected by the processor and the tamper-resistant circuit 106; and erasing the encryption key 300 stored in the volatile memory 302 such that an operation of the tamper-resistant portable computing device 10 is disabled permanently.

The steps may further include generating a hacking detection electrical output signal 203, by the tamper-resistant circuit 106 and processor 102, wherein the hacking detection electrical output signal 203 may be passed through to one of the conductive metal springs 108, 109 and to the conductive pattern 200; and inputting a hacking detection electrical input signal 204 which may be passed through from the conductive pattern 200 to the other conductive metal spring 108 or 109 into the tamper-resistant circuit 106 and the processor 102.

FIG. 8 is a schematic illustration of a system for a payment transaction using the tamper-resistant portable stick computer device 10 according to the present invention; and FIG. 9 is another schematic illustration of a display of application for a payment transaction and the tamper-resistant portable stick computer device according to the present invention.

As shown FIGS. 8-10, the payment transaction system 500 using a tamper-resistant portable stick computer device 10 as a payment device may include representative external devices 550 connected to the portable computer device 10 having a CPU for payment transaction, such as a monitor 520 with a video input port 501, a contact/contactless card & PIN entry device 503, printer 504, cash register 505, USB hub 502, barcode scanner 506, magnet card reader 519, power supply 507. In order for the payment system 500 to operate, the video output port 517 of invention 10 must be connected to the video input port 501 mounted on the monitor 520. To connect to one or more external devices 550 (502, 503, 504, 505, 506, 513, 514, 519), a user connects a USB hub 502 having more than one USB port 512 to a USB port 508 of the portable computer device 10. The external devices 502, 503, 504, 505, 506, 513, 514, and/or 519 that are connectable to the USB hub 502 are interchangeable and the number of devices is not limited, e.g. many of the external devices can further be connected to other devices to form a daisy-chain of devices that ultimately leads to the portable computer device 10 of the present invention. All wireless communications built into the portable computer device 10 are also connected to wireless devices such as the barcode scanner 506 via Wi-Fi and Bluetooth 518. External devices 502, 503, 504, 505, 506, 513, 514, 519 include wireless 516 and/or wired 515 connectivity options. The USB hub 502 is a market product and the number of ports 512 of the USB Hub 502 to connect to external devices is at least one but preferably more than one when connecting to multiple external devices, and the portable computer device 10 does not limit the number of ports 512 of the USB Hub 502 to be connected.

Various information 600 necessary for the operation of the shop is displayed on the monitor 520; for example, such information 600 may include (but is not limited to) product inventory, customer payment card number, customer information, product type, printing information, card transaction status, orders status, shipping information and status, menu, and prices etc. Additionally, Internet-based programs 603 for managing and controlling payment transactions may be displayed on the monitor 520. The internet web browser 601, and applications 330 and programs 602 managing and controlling payment transactions such as point of sale (POS) system or programs are running in the portable computer device 10. The applications and programs 602 saved in the memory of the portable computer device 10 may include one or more internet web browsers 601 and internet-based programs 603 executing on the portable computer device 10. The signal output from the portable computer device 10 is input into the monitor's video input port 501 and displayed on the monitor 520 screen. Cursor 605 adjustment and touch screen operation 604 of users for monitor 520 screen operation can be used by connecting touch screen signal 511 outputted from port 510 of monitor 520 to USB hub ports 512. At the same time, users can connect to the port 510 a keyboard 513 and mouse 514 by wire 515 or wireless 516 connections. The touch screen signal 511 and the wired connection 515 are USB signals corresponding to the input-related functions and are connected to any port 512 among the USB hub ports. Applications and programs 602 running on the portable device 10 control and manage all external devices 502, 503, 504, 505, 506, 513, 514, 519 connected to the tamper-proof portable computer device 10. Accordingly, merchants may replace a workstation operating their payment transaction system with the payment transaction system 500 using a tamper-resistant portable stick computer device 10.

FIG. 11 shows a side view of an interior of tamper-resistant portable stick computer device according to the present invention. FIG. 12 shows another side view of the interior of tamper-resistant portable stick computer device according to the present invention.

As shown in FIGS. 11-12, the substrate 120 may include a metallic conductive rectangular border 150 in contact with all edges of a cover to prevent electromagnetic interference (EMI) or radio frequency interference (RFI) from impacting sensitive electronics. Preferably, the conductive border 150 surrounds about the electric components 20, and a bottom of the tamper-resistant covers 107, 107′ is disposed on the conductive border 20.

As shown FIG. 1-12, preferably, a system 500 for protecting information of payment transactions, which includes a tamper-resistant portable computing device 10, a display 520 connected with the tamper-resistant portable computing device 10; and an external device 550 for processing the payment transactions. The tamper-resistant portable computing device 10 includes a case 100, 113, a processor 102 and a tamper-resistant circuit 106, a substrate 120 constructed to mount at least one of electric components 20 on a side 122 of the substrate 120, and wherein the electric components 20 include the processor 102, a first cover 107 to cover the electric components 20 mounted on the side 122 of the substrate 120 wherein the first cover 170 includes a conductive pattern 200 inside of the first cover 107, and wherein the conductive pattern 200 includes electric contacts 201, 202 on each end of the conductive pattern 200; and conductive metal springs 108, 109 disposed on the substrate 120 in contact with the electric contacts 201, 202 of the conductive pattern 200 to establish an electrical connection between the tamper-resistant circuit 106 and the first cover 107.

The tamper-resistant portable computing device 20 is operative to protect the information 600 of the payment transactions by the steps of, The tamper-resistant portable computer device 10: encrypting, via an encryption key 300 in a volatile memory 302, a bootloader 310, a kernel 320, and an application 330 and storing an encrypted bootloader 310 in the volatile memory 302; decrypting, by the encrypted bootloader 310, the kernel 320 and the application 330 encrypted by the encryption key 300 in the volatile memory 302, and executing the application 330; detecting, by the processor 102 and the tamper-resistant circuit 106, a hacking detection signal 203, 204 when physical tampering of the tamper-resistant portable computer device 10 disconnects the electrical connection between the first cover 107 and the tamper-resistant circuit 106; displaying the disconnection status of the electrical connection of the tamper-resistant circuit 106 on the display when the hacking detection signal 203 or 204 is detected by the processor 102 and the tamper-resistant circuit 106; and erasing the encryption key 300 stored in the volatile memory 302 such that an operation of the tamper-resistant portable computing device 10 is disabled permanently.

The steps may further include generating a hacking detection electrical output signal 203, by the tamper-resistant circuit 106 and processor 102, wherein the hacking detection electrical output signal 203 may be passed through to one of the conductive metal springs 108, 109 and to the conductive pattern 200; and inputting a hacking detection electrical input signal 204 which may be passed through from the conductive pattern 200 to the other conductive metal spring 108 or 109 into the tamper-resistant circuit 106 and the processor 102. The first cover 107 further includes both a top surface and side walls defining a cavity 206 enclosing the electronic components 20. The first cover 107 further includes an insulating coating layer of an inner surface of the first cover 107 and a rigid portion 140 of an outer surface of the first cover 107, and wherein the conductive pattern 200 is disposed between the insulating coating layer 130 and the rigid portion 140. The substrate 120 includes a conductive border 150 on the substrate 120 wherein the conductive border 150 surrounds about the electric components 20, and wherein a bottom of the first cover 107 is disposed on the conductive border 150.

Additionally, the system 500 includes a second cover 107′ to cover at least one additional electronic components 20 mounted on an opposite side 124 of the substrate 120 wherein the first cover 107 and the second cover 107′ are substantially the same shape and size, and wherein the second cover 107′ is disposed to be substantially aligned with respect to the first cover 107. A bottom of the first cover 107 and the second cover 107′ are disposed on the conductive border 150. The external device is connected with the tamper-resistant portable computing device 20 through a universal serial bus (USB) port 512 and wireless Bluethooth.

The steps may further include: receiving the information of the payment transactions through the external device for processing the payment transactions and the payment. The external device 550 is a contact/contactless card and PIN entry device 503, a cash register 505, a barcode scanner 506, or a magnet card reader 519.

The application 330 may be a Point of Sale (POS) program stored in a non-volatile memory 103 of the tamper-resistant portable computing device 10 and the information 600 of payment transactions is a payment card number, user information, a card transaction status, or an order status stored in a non-volatile memory 103 of the tamper-resistant portable computing device 10.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A system for protecting information of payment transactions, the system comprising:
a tamper-resistant portable computing device comprising:
a case;
a processor and a tamper-resistant circuit;
a substrate constructed to mount at least one of electric components on a side of the substrate, and wherein the electric components include the processor;
a first cover to cover the electric components mounted on the side of the substrate wherein the first cover includes a conductive pattern inside of the first cover, and wherein the conductive pattern includes electric contacts on each end of the conductive pattern; and
conductive metal springs disposed on the substrate in contact with the electric contacts of the conductive pattern to establish an electrical connection between the tamper-resistant circuit and the first cover,
a display connected with the tamper-resistant portable computing device; and
an external device for processing the payment transactions, wherein the tamper-resistant portable computing device is operative to protect the information of the payment transactions by the steps of, the tamper-resistant portable computing device:
encrypting, via an encryption key in a volatile memory, a bootloader, a kernel, and an application and storing an encrypted bootloader in the volatile memory;
decrypting, by the encrypted bootloader, the kernel and the application encrypted by the encryption key in the volatile memory, and executing the application;
detecting, by the processor and the tamper-resistant circuit, a hacking detection signal when physical tampering of the tamper-resistant portable computing device disconnects the electrical connection between the first cover and the tamper-resistant circuit;
displaying the disconnection status of the electrical connection of the tamper-resistant circuit on the display when the hacking detection signal is detected by the processor and the tamper-resistant circuit; and
erasing the encryption key stored in the volatile memory such that an operation of the tamper-resistant portable computing device is disabled permanently,
wherein the volatile memory which is stored the encryption key, the tamper-resistant circuits and the first cover receive power by a coin battery when an external power source is not provided.

2. The system of claim 1, wherein the steps further include:
generating a hacking detection electrical output signal, by the tamper-resistant circuit and the processor, wherein the hacking detection electrical output signal is passed through to one of the conductive metal springs and to the conductive pattern; and
inputting a hacking detection electrical input signal which is passed through from the conductive pattern to the other conductive metal spring into the tamper-resistant circuit and the processor.

3. The system of claim 1, wherein the first cover further includes both a top surface and side walls defining a cavity enclosing the electronic components, and wherein the conductive metal springs are made of conductive elastomers.

4. The system of claim 1, wherein the first cover further includes a insulating coating layer of an inner surface of the first cover and a rigid portion of a outer surface of the first cover, and wherein the conductive pattern is disposed between the insulating coating layer and the rigid portion.

5. The system of claim 1, wherein the substrate includes a conductive border on the substrate wherein the conductive border surrounds about the electric components, and
wherein a bottom of the first cover is disposed on the conductive border.

6. The system of claim 1, further comprising a second cover to cover at least one additional electronic components mounted on an opposite side of the substrate, wherein the first cover and the second cover are the same shape and size, and wherein the second cover is disposed to be substantially aligned with respect to the first cover.

7. The system of claim 1, wherein the external device is connected with the tamper-resistant portable computing device through a universal serial bus (USB) port.

8. The system of claim 7, further comprising the step of:
receiving the information of the payment transactions through the external device for processing the payment transactions and the payment,
wherein the external device is a contact/contactless card and PIN entry device, a cash register, a barcode scanner, or a magnet card reader.

9. The system of claim 1, wherein the application is a Point of Sale (POS) program stored in a non-volatile memory of the tamper-resistant portable computing device, and wherein the information of payment transactions is a payment card number, user information, a card transaction status, or an order status stored in a non-volatile memory of the tamper-resistant portable computing device.

10. A tamper-resistant portable computing device for protecting information of payment transactions and wherein the tamper-resistant portable computing device is connected with a display, the tamper-resistant portable computing device comprising:
a case;
a processor and a tamper-resistant circuit;
a substrate constructed to mount at least one of electric components on a side of the substrate, and wherein the electric components include the processor and the tamper-resistant circuit;
a first cover to cover the electric components mounted on the side of the substrate wherein the first cover includes a conductive pattern inside of the first cover, and wherein the conductive pattern includes electric contacts on each end of the conductive pattern; and
conductive metal springs disposed on the substrate in contact with the electric contacts of the conductive pattern to establish an electrical connection between the tamper-resistant circuit and the first cover,
wherein the tamper-resistant portable computing device is operative to protect the information of the payment transactions by the steps of, the tamper-resistant portable computing device:
encrypting, via an encryption key in a volatile memory, a bootloader, a kernel, and an application and storing an encrypted bootloader in the volatile memory;
decrypting, by the encrypted bootloader, the kernel and the application encrypted by the encryption key in the volatile memory, and executing the application;
detecting, by the processor and the tamper-resistant circuit, a hacking detection signal when physical tampering of the tamper-resistant portable computing device disconnects the electrical connection between the first cover and the tamper-resistant circuit;
displaying the disconnection status of the electrical connection of the tamper-resistant circuit on the display when the hacking detection signal is detected by the processor and the tamper-resistant circuit; and
erasing the encryption key stored in the volatile memory such that an operation of the tamper-resistant portable computing device is disabled permanently,
wherein the volatile memory which is stored the encryption key, the tamper-resistant circuits and the first cover receive power by a coin battery when an external power source is not provided.

11. The tamper-resistant portable computing device of claim 1, wherein the steps further include:
generating a hacking detection electrical output signal, by the tamper-resistant circuit and processor, wherein the hacking detection electrical output signal is passed through to one of the conductive metal springs and to the conductive pattern; and
inputting a hacking detection electrical input signal which is passed through from the conductive pattern to the other conductive metal spring into the tamper-resistant circuit and the processor.

12. The tamper-resistant portable computing device of claim 1, wherein the first cover further includes both a top surface and side walls defining a cavity enclosing the electronic components, and wherein the conductive metal springs are made of conductive elastomers.

13. The tamper-resistant portable computing device of claim 1, wherein the first cover further includes a insulating coating layer and a rigid portion, and wherein the conductive pattern is disposed between the insulating coating layer and the rigid portion.

14. The tamper-resistant portable computing device of claim 1, wherein the substrate includes a conductive border surrounding about the electric components, and
wherein a bottom of the first cover is disposed on the conductive border.

15. The tamper-resistant portable computing device of claim 1, further comprising a second cover to cover at least one additional electronic components mounted on an opposite side of the substrate wherein the first cover and the second cover are the same shape and size, and wherein the second cover is disposed to be substantially aligned with respect to the first cover.

16. The tamper-resistant portable computing device of claim 1, wherein the application is a Point of Sale (POS) program stored in a non-volatile memory of the tamper-resistant portable computing device and the information of payment transactions is a card number, user information, a card transaction status, or an order status.

17. A method for protecting information of payment transactions by a tamper-resistant portable computing device comprising the steps of:
encrypting, via an encryption key in a volatile memory, a bootloader, a kernel, and an application and storing an encrypted bootloader in the volatile memory;
decrypting, by the encrypted bootloader, the kernel and the application encrypted by the encryption key in the volatile memory, and executing the application;
detecting, by the processor and the tamper-resistant circuit, a hacking detection signal when physical tampering of the tamper-resistant portable computing device disconnects the electrical connection between the first cover and the tamper-resistant circuit;
displaying the disconnection status of the electrical connection of the tamper-resistant circuit on the display when the hacking detection signal is detected by the processor and the tamper-resistant circuit; and
erasing the encryption key stored in the volatile memory such that an operation of the tamper-resistant portable computing device is disabled permanently.

18. The method of claim 17 further comprising the steps of:
generating a hacking detection electrical output signal, by the tamper-resistant circuit and processor, wherein the hacking detection electrical output signal is passed through to one of the conductive metal springs and to the conductive pattern; and
inputting a hacking detection electrical input signal which is passed through from the conductive pattern to the other conductive metal spring into the tamper-resistant circuit and the processor.

19. The method of claim 17, further comprising the step of:
receiving the information of the payment transactions through an external device for processing the payment transactions and the payment,
wherein the external device is a contact/contactless card and PIN entry device, a cash register, a barcode scanner, printer or a magnet card reader.

20. The method of claim 19, wherein the application is a Point of Sale (POS) program stored in a non-volatile memory of the tamper-resistant portable computing device and the information of payment transactions is a payment card number, user information, a card transaction status, or an order status.
